(19) United States
(12) Patent Application Publication
(10) Pub. No.: US 2017/0237684 A1
(43) Pub. Date: Aug. 17, 2017

(54) DECENTRALIZED RESOURCE ALLOCATION

(71) Applicant: Webscale Networks, Inc., Boulder, CO (US)

(72) Inventors: James Thomas Smith II, Boulder, CO (US); Vladimir Vladimirovich Shestak, Boulder, CO (US)

(21) Appl. No.: 15/275,994

(22) Filed: Sep. 26, 2016

Related U.S. Application Data
(63) Continuation of application No. 13/908,497, filed on Jun. 3, 2013, now abandoned.
(60) Provisional application No. 61/654,992, filed on Jun. 4, 2012.

(51) Int. Cl. H04L 12/911; H04L 29/08

(52) U.S. Cl. CPC H04L 47/783; H04L 67/2833; H04L 67/101; H04L 67/2809; H04L 67/1023; H04L 67/2895; H04L 67/16; H04L 67/1034; H04L 41/5083

(57) ABSTRACT

The disclosure is directed to routing service requests over a network (50). Service requests may be routed over a network (50) based upon deriving optimized weights for each of a plurality of service providers (130) within a service provider set (135), receiving a plurality of service requests at a broker (110) within the network (50), and routing each of the plurality of service requests from the broker (110) to the plurality of service providers (130) on the network (50). In some implementations, the optimized weights for each of the plurality of service providers (130) may be derived using a non-linear function. In some implementations, the optimized weights for the plurality of service providers (130) associated with a broker (110) may collectively define a weighted distribution. The plurality of service requests may be routed by a broker (110) using its corresponding weighted distribution.

### CROSS-REFERENCE TO RELATED APPLICATIONS

This patent application is a continuation of U.S. patent application Ser. No. 13/908,497, entitled “DECENTRALIZED RESOURCE ALLOCATION,” and filed on Jun. 3, 2013, which claims priority to U.S. Provisional Patent Application Ser. No. 61/654,992, entitled “DECENTRALIZED RESOURCE ALLOCATION,” and filed on Jun. 4, 2012; the entirety of the above applications is incorporated by reference herein as if set forth in full.

### FIELD OF THE INVENTION

The present invention is generally directed to routing service requests from one or more service requesters/users to one or more service providers.

### BACKGROUND

In a distributed hosting environment, the hosted service is replicated to multiple servers (virtual or physical) to increase the performance of the service. Typically, access to the collection of servers is indirected through a hardware or software system acting as a reverse proxy. The reverse proxy distributes incoming requests for data to the collection of servers using a resource allocation technique (e.g., round-robin, random, shortest queue). In this manner, the reverse proxy enables the servers to collectively process a higher volume of requests than any single server could handle. However, the reverse proxy introduces a single point of failure when added to such distributed systems. That is, if the reverse proxy were to become unavailable, then the entire distributed system would be unavailable.

### SUMMARY

The present invention is generally directed to routing service requests on a network. Service requests may be issued by one or more users or service requesters on the network, and the present invention may distribute or allocate such service requests to service providers on the network, where these service providers are within a service provider set. The present invention may be in the form of a method for routing service requests over a network, or may be in the form of a system (e.g., a broker or a broker set) that is configured to route service requests in the manner addressed herein.

A first aspect of the present invention is directed to routing service requests over a network (e.g., a public cloud; a private cloud). Optimized weights for each service provider of a service provider set (having multiple service providers) may be derived using a non-linear function. The service providers of this service provider set are on the network. The optimized weights for the service providers of the service provider set collectively define a weighted distribution. A plurality of service requests are received by a broker over the network (e.g., the broker is part of the network). Each of the received service requests are routed over the network by the broker using the noted weighted distribution.

A second aspect of the present invention is directed to routing service requests over a network (e.g., a public cloud; a private cloud). Optimized weights for each service provider of a service provider set (having multiple service providers) may be derived by a broker using status information on each of the service providers within the service provider set. The service providers of this service provider set are on the network. The optimized weights for the service providers of the service provider set collectively define a weighted distribution. A plurality of service requests are received by the broker over the network. Each of the received service requests are routed over the network by the broker using the noted weighted distribution.

A third aspect of the present invention is directed to routing service requests over a network (e.g., a public cloud; a private cloud) having a plurality of brokers. Each broker derives its own weighted distribution using temporally independent status information on each service provider of its corresponding service provider set on the network (where each service provider set has multiple service providers). The weighted distribution for each broker is in the form of an optimized weight for each service provider of its corresponding service provider set. A plurality of service requests are received by each broker over the network. Received service requests are routed over the network by each broker using its corresponding weighted distribution.

A number of feature refinements and additional features are separately applicable to each of above-noted first, second, and third aspects of the present invention. These feature refinements and additional features may be used individually or in any combination in relation to each of the first, second, and third aspects.

Optimized weights for each service provider of a given service provider set (where the service provider set may have any appropriate number of multiple service providers on the network) may be derived using a non-linear function. This derivation may be undertaken by a broker-a broker may derive optimized weights for each service provider of its corresponding service provider set (e.g., a broker may be configured to undertake the noted derivation, for instance using at least one processor). In one embodiment, the broker includes a front end and a back end. Service requests may be received over the network by a given broker at its front end, and received service requests may be routed over the network by a given broker from its back end. In any case, the sum of optimized weights that are derived for a weighted distribution to be used by a broker in routing service requests over the network may be equal to “1.” Service requests that are routed by a broker each may be in the form of at least one transmission of one or more data packets including destination or address information (e.g., an IP address).

A broker may use price information on service providers within its corresponding service provider set to derive the optimized weights for these service providers. This price information may be calculated by a broker (e.g., using at least one processor). In one embodiment, a broker may receive status information (e.g., over the network) on each service provider within its corresponding service provider set. Status information on each service provider may be based upon a relationship between a maximum number of connections for a given service provider and a number of busy connections for this same service provider. In any case, the price of each service provider in a given service provider set may be calculated (e.g., by the broker, for instance using at least one processor) based upon this status information. In one embodiment, a broker may acquire status information directly from each service provider of its corresponding service provider set (e.g., by a broker issuing a request for status information over the network to each such service provider). In one embodiment, a broker may acquire the noted status information indirectly, for instance by the broker itself generating status information on each service provider of its corresponding service provider set (e.g., using at least one processor) based upon input that the broker acquires from at least one other broker within the same network.

A broker may set a preference for each service provider in its corresponding service provider set. These preferences may be based upon a latency of the network. The network latency may be measured in any appropriate manner (e.g., by the broker), and may be measured from the broker to each service provider in its corresponding service provider set. In one embodiment, each preference is inversely proportional to its corresponding measured latency.

Optimized weights for a given weighted distribution may be derived (e.g., using at least one processor) and used by a broker to route service requests over the network. The optimized weights for a given weighted distribution may be updated on any appropriate basis (e.g., the derivation of optimized weights may be repeated on any appropriate basis). One embodiment has the derivation of optimized weights for a given weighted distribution being periodically updated. In any case, a first portion of service requests may be routed over the network by a given broker using a first weighted distribution (e.g., a first derivation of optimized weights that defines the first weighted distribution), and a second weighted distribution (e.g., from a subsequent-in-time derivation of optimized weights to define the second weighted distribution) may be used by this same broker to route a second portion of service requests over the network (e.g., the second portion being “later received” in relation to the first portion).

The routing of service requests from a broker, over the network, and using its corresponding weighted distribution may include transmitting each received service request to a particular service provider within its corresponding service provider set on the network. Service requests may be transmitted from a broker to a particular service provider within its corresponding service provider set on the network. In one embodiment, the optimized weights of a weighted distribution for a given broker are converted into a cumulative probability mass function, and service requests received by this broker are routed by the broker over the network using this cumulative probability mass function (e.g., a routed service request from a broker having associated destination/address information, for instance an IP address).

Multiple brokers may be utilized (e.g., a broker set) to distribute service requests over the network, each of which may be configured/operated in accordance with the foregoing. For instance, each of these brokers may derive their own weighted distribution (an optimized weight for each service provider in its corresponding service provider set, for instance using at least one processor) using temporally independent status information on each service provider within its corresponding service provider set. “Temporally independent status information” may be characterized as the optimized weights for each of the brokers in the broker set not needing to be based upon status information from the same point in time. In any case, service requests received by a given broker over the network may then be routed over the network by the broker based upon its corresponding weighted distribution.

The noted broker set may be characterized as collectively functioning as a reverse proxy server for distributing service requests to service providers on the network. Although multiple brokers may be utilized, each broker may operate/function autonomously. How a given broker in a broker set allocates service requests need not be dependent upon how any other brokers in the same broker set allocates service requests. As such, a particular broker in a broker set being unavailable in any respect should not preclude the remaining brokers in the broker set from continuing to allocate/distribute service requests.

Service requests may be transmitted to a given broker in any appropriate manner, for instance over the network and which may be of any appropriate type (e.g., the Internet; a public cloud; a private cloud). A service request may be associated with a user or service requester, and may be transmitted to a broker using a computer of any appropriate type (e.g., a desktop computer; a laptop computer; a tablet computer; a smart phone). Service requests may be in any appropriate form, for instance in the form of a computer-generated data packet(s) that is transmitted over an appropriate communication link to a broker.

Service requests may be sent from a given broker (e.g., to a service provider) in any appropriate manner, for instance over the network and which may be of any appropriate type (e.g., the Internet; public cloud; a private cloud). Each service provider in the service provider set for a given broker may be of any appropriate type, for instance in the form of a Web server. Service requests may be issued by a broker in any appropriate form, for instance as at least one transmission of one or more data packets including destination or address information (e.g., an IP address) and which may be sent on a communication link of any appropriate type.

At least one broker is used in relation to the present invention. As noted, the present invention may be in the form of how service requests are allocated/distributed using such a broker. However, the present invention may also be in the form of a broker that is configured to allocate/distribute service requests in the above-noted manner. For instance, a given broker may include a data processing system (e.g., one or more processors that are arranged in any appropriate manner and that use any appropriate processing architecture) and memory of any appropriate type or types (e.g., one or more data storage devices of any appropriate type and arranged in any appropriate data storage architecture). This data processing system may be configured to derive optimized weights for each service provider in its corresponding service provider set in accordance with the foregoing. One or more communication ports of any appropriate type may be used by a given broker to receive service requests. One more communication ports of any appropriate type may be used by a given broker to transmit service requests in accordance with its own weighted distribution.

Any feature of any other various aspects of the present invention that is intended to be limited to a “singular” context or the like will be clearly set forth herein by terms such as “only,” “single,” “limited to,” or the like. Merely introducing a feature in accordance with commonly accepted antecedent basis practice does not limit the corresponding feature to the singular (e.g., indicating that the present invention utilizes “a broker” alone does not mean that the present invention utilizes only a single broker). Moreover, any failure to use phrases such as “at least one” also does not limit the corresponding feature to the singular (e.g., indicating that the present invention utilizes “a broker” alone does not mean that the present invention utilizes only a single broker). Use of the phrase “at least generally” or the like in relation to a particular feature encompasses the corresponding characteristic and insubstantial variations thereof. Finally, a reference of a feature in conjunction with the phrase “in one embodiment” does not limit the use of the feature to a single embodiment.

### BRIEF DESCRIPTION OF THE FIGURES

FIG. 1 is a schematic of one embodiment of a network that utilizes a set of brokers to allocate service requests from users to service providers.

FIG. 2 is one embodiment of a protocol that may be used by each of the brokers from the network of FIG. 1 in allocating service requests to the various service providers.

FIG. 3 is one embodiment of a status acquiring protocol that may be used by each of the brokers from the network of FIG. 1 in acquiring/requesting status information from/relating to the various service providers.

FIG. 4 is another embodiment of a status acquiring protocol that may be used by each of the brokers from the network of FIG. 1 in acquiring/requesting status information from/relating to the various service providers.

FIG. 5 is a diagram of a broker routing procedure having weights converted into a cumulative probability mass function used for selecting service providers for transmitting service requests received by a broker from the network of FIG. 1.

FIG. 6 is a schematic of one embodiment of a data processing system of a broker for allocating service requests from users to service providers.

### DETAILED DESCRIPTION

The disclosure relates to a system and method for distributing/allocating service requests, preferably on a decentralized basis. A resource allocation technique and its implementation may be used to eliminate a single point of failure in reverse proxying. A reverse proxy function is provided to multiple service providers by a collection of multiple brokers (e.g., reverse proxy load balancers) in a distributed system. Incoming requests are received from service requesters at multiple brokers where they are routed to multiple service providers for processing. All service requests originate with service requesters or users (e.g., a person accessing the distributed system via a web browser or a computer system requesting processing from the distributed system). Service provider capacity and service provider utilization may be acquired to facilitate a price calculation for each service provider. In turn, each broker optimization problem may be optimized such that service requests may be distributed/allocated on a decentralized basis.

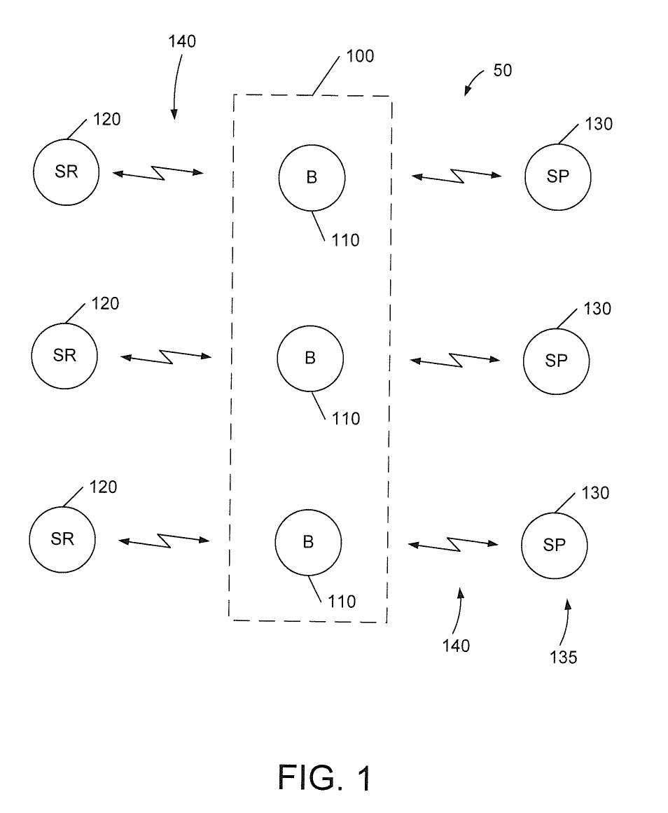

FIG. 1 is a schematic of one embodiment of a network 50 for distributing/allocating service requests. The network 50 may be in the form of a public cloud or a private cloud. The network 50 may include a plurality of users or service requesters 120, a broker set or group 100, and a service provider set or group 135. Each service requester 120 may communicate with the broker set 100 over any appropriate communication link 140 (e.g., via the Internet). Similarly, the broker set 100 may communicate with the service provider set 135 over any appropriate communication link 140 (e.g., via the Internet).

A service requester 120 may access the broker set 100 in any appropriate manner, for instance using a computer of any appropriate type (e.g., a desktop computer; a laptop computer; a tablet computer; a smart phone). Any appropriate number of service requesters 120 may be part of the network 50 at any given time. It should be appreciated that a given service requester 120 may be part of the network 50 on a full-time basis or only on a part-time basis (e.g., when there is an active communication link 140 between a given service requester 120 and the broker set 100).

The broker set 100 may collectively function as a reverse proxy server for distributing service requests to service providers 130. One or more brokers 110 may define the broker set 100. Any appropriate number of brokers 110 may be utilized by the broker set 100. A service request from any service requester 120 may be transmitted over the network 50 to any broker 110 within the broker set 100 on any appropriate basis.

The brokers 110 in the broker set 100 may operate/function autonomously—how a given broker 110 allocates service requests need not be dependent upon how other brokers 110 in the broker set 100 are allocating service requests. The network 50 may be configured such that a broker 110 becoming unavailable does not preclude other brokers 110 from continuing to allocate/distribute service requests. The “side” of a given broker 110 that communicates with the service requesters 120 may be referred to as the “front end.” The “side” of a given broker 110 that communicates with its service provider set 135 may be referred to as the “back end.”

The service provider set 135 may be defined by a plurality of service providers 130. The plurality of service providers 130 within a given service provider set 135 may be associated with a common entity. For instance, a service provider set 135 may be characterized as a Web site having a plurality of servers or service providers 130 (e.g., each service provider 130 may be in the form of a Web server (e.g., actual or virtual)). Any appropriate number of service providers 130 may define a given service provider set 135. A given service provider 130 could be a member of one or more service provider sets 135.

Each broker 110 in the broker set 100 may be associated with the same service provider set 135, although such may not be required in all instances. A given broker 110 may be associated with one service provider set 135, while another broker 110 may be associated with a different service provider set 135. These different service provider sets 135 may entail having no common or overlapping service providers 130, or these different service provider sets 135 could have at least some overlap in service providers 130 (e.g., a given service provider 130 could be in two or more service provider sets 135).

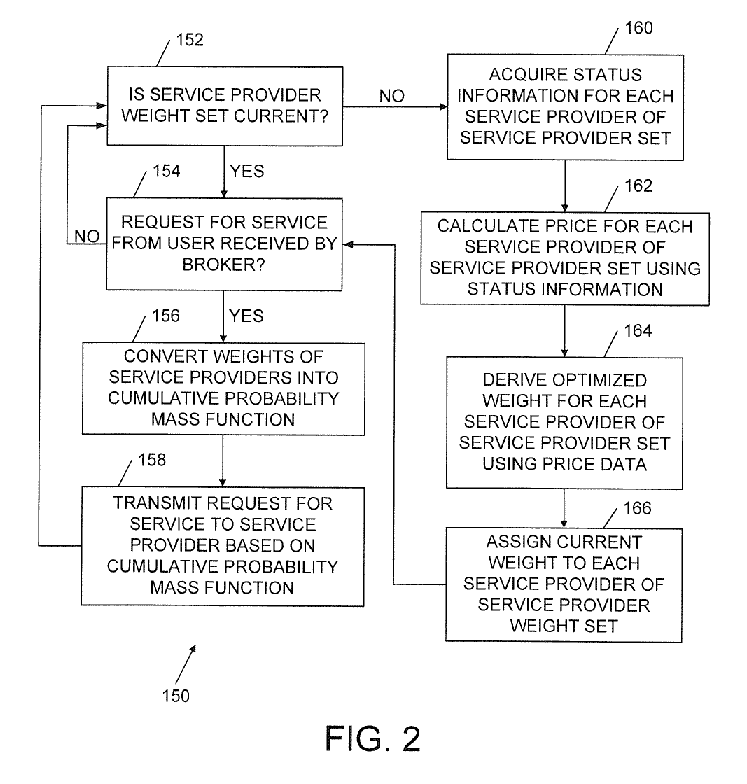

FIG. 2 presents one embodiment of a protocol 150 which may be utilized by each broker 110 to distribute or allocate service requests over the network 50 from one or more of the service requesters 120 to the service providers 130 within its corresponding service provider set 135.

Each service provider 130 within the service provider set 135 is assigned what may be characterized as an “optimized weight” by each broker 110. The optimized weights for each of the service providers 130 within the service provider set 135 collectively define a weighted distribution on a broker 110-by-broker 110 basis. That is, the optimized weights for each of the service providers 130 for one broker 110 need not be, and may not be, of the same value in relation to the weights assigned by another of the brokers 110 to these same service providers 130. In one embodiment, the sum of the optimized weights for each of the service providers 130 within a service provider set 135 for a given broker 110 is equal to “1.”

Each broker 110 may update its set of optimized weights on any appropriate basis (e.g., periodically; in accordance with an algorithm; on some timed basis). In the event that the set of optimized weights associated with a given broker 110 are due for an update, the protocol 150 proceeds from step 152 to step 160. Step 160 is directed to acquiring status information on each service provider 130 of the service provider set 135 for the particular broker 110. Status information on a particular service provider 130 may relate to the capacity of this particular service provider 130 and the demand for this particular service provider 130. For instance, the status information for a particular service provider 130 may be the number of connections or threads to the service provider 130 that are currently available for communicating with the service provider 130 (e.g., the differential between the maximum number of connections or threads for the service provider 130, minus the number of busy connections or threads (e.g., those connections or threads that are currently being utilized to communicate with the service provider 130)). The capacity of a particular service provider 130 may refer to the advertised capacity or the true capacity of the service provider 130. The advertised capacity denotes a set point where higher utilization of the service provider will result in an increase in price for that service provider as opposed to a failure within the system. True capacity represents a hard limit on the service provider such that increase in utilization above that limit would result in a failure. The capacity of a service provider 130, as referred to herein, is the advertised capacity.

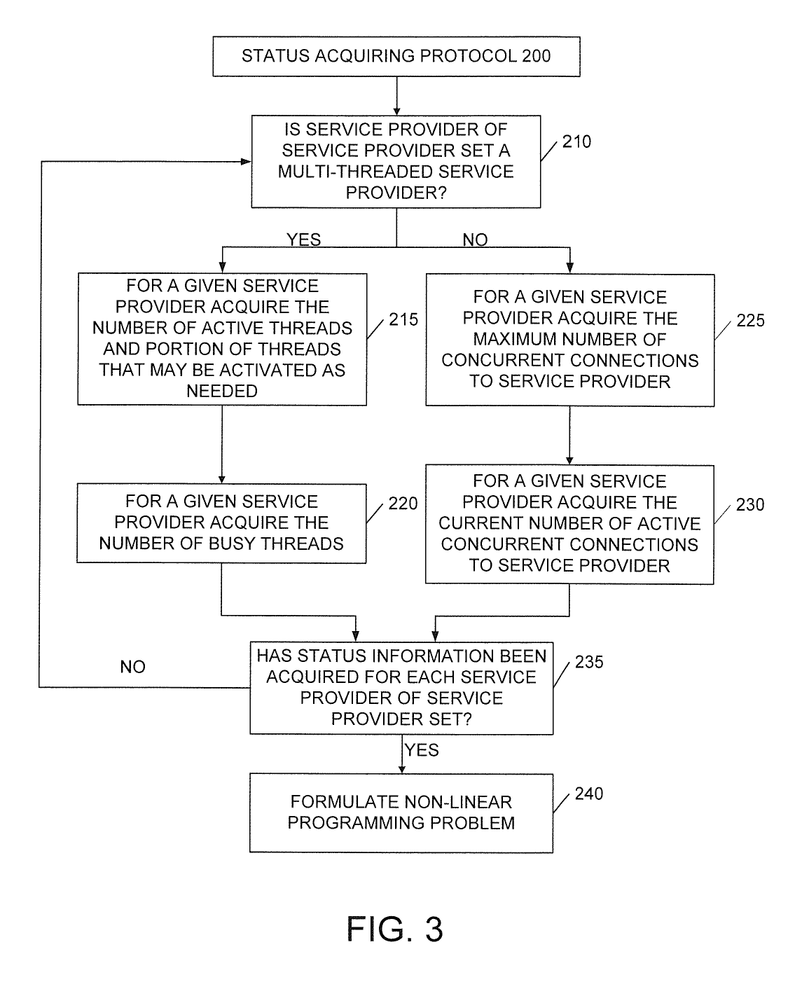

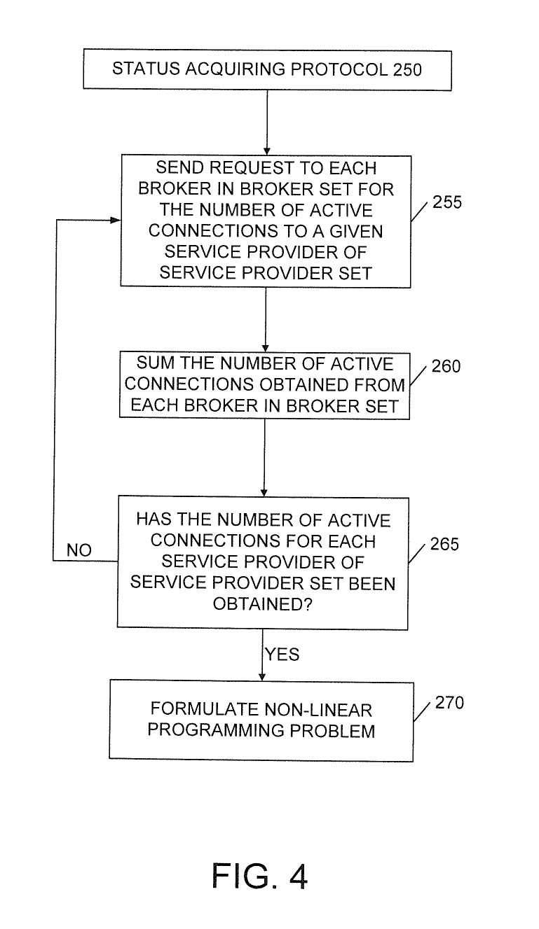

Status information on each service provider 130 within a service provider set 135 may be acquired by a broker 110 on any appropriate basis. For instance, a broker 110 could request status information directly from each service provider 130 within its corresponding service provider set 135 (e.g., in the manner discussed below in relation to the status acquiring protocol 200 of FIG. 3). The broker 110 could use status information received from a service provider 130 over the network 50 “as is,” or the broker 110 could use status information received from a service provider 130 over the network 50 to derive status information. Another option for a broker 110 to acquire status information on each service provider 130 within its corresponding service provider set 135 is to poll other brokers 110 within the broker set 100 to allow the requesting broker 110 to estimate/calculate the status information for each service provider 130 within its corresponding service provider set 135 (e.g., to identify the extent to which other brokers 110 are transmitting requests to the service providers 130 and in the manner discussed below in relation to the status acquiring protocol 250 of FIG. 4)).

Each broker 110 will calculate a price (e.g., using at least one processor) for each service provider 130 within its service provider weight set 135 (step 162) using the status information acquired pursuant to step 160. This will be discussed in more detail below. Optimized weights for each service provider 130 (one weight per service provider 130) are derived by each broker 110 (step 164) using the price data acquired pursuant to step 162. This will be discussed in more detail below. In one embodiment, the derivation associated with step 164 utilizes a non-linear function (discussed below). Step 166 of the protocol 150 is directed to assigning the optimized weights from step 164 to what is now an updated or current service provider weight set for the given broker 110.

With the service provider weight set being current, the protocol 150 of FIG. 2 proceeds to step io 154. Step 154 is directed to determining if a given broker 110 has received a request for service over the network 50 from one or more service requesters 120. Each broker 110 may very well continually receive a relatively large volume of service requests from various service requesters 120. Assuming that there are service requests to be distributed by a given broker 110, the broker 110 transmits these service requests over the network 50 to one or more of the service providers 130 in its service provider set 135 using its own optimized weights (steps 160-166). In the illustrated embodiment, the optimized weights for the service providers 130 of a given broker 110 are converted into a cumulative probability mass function (step 156). Service requests from the service requesters 120 are then transmitted by the broker 110 to the various service providers 130 within its service provider set 135 using this cumulative probability mass function (step 158).

Each broker 110 may execute the protocol 150 of FIG. 2 independently of other brokers 110 within the broker set 100. For instance, the brokers 110 need not be synchronized on any basis for updating their respective optimized weights (e.g., optimized weights for each of the brokers 110 need not be based upon status information from the same point in time). Although two or more brokers 110 in the broker set 100 could acquire status information from their corresponding service provider set 135 that is associated with a common point in time, such is not required by the brokers 110 of the broker set 100. This may be referred to as being “temporally independent status information” on the various service providers 130 for use by the brokers 100 in deriving optimized weights for the service providers 130 in its corresponding service provider set 135.

FIG. 3 presents one embodiment of a protocol 200 which may be utilized by each broker 110 to acquire and/or request status from each service provider 130 within its corresponding service provider set 135 (e.g., step 160 of protocol 150-FIG. 2). As discussed above, a broker 110 can request status information from each service provider 130 within its corresponding service provider set 135. This may be done by a direct network request (e.g., over the network 50) to the service providers 130. Many service providers (e.g., common web server implementations such as NGinX and Apache) offer a well known mechanism for obtaining the current status for the service provider. For example, an Apache web server provides the well known module mod_status that provides the current number of busy and idle threads. Status acquiring protocol 200 is generally directed towards acquiring status information on each service provider 130 by requesting the status information from each service provider 130. The status information may include a capacity of service provider 130 and a flow of service provider 130 (e.g., the current utilization of that service provider 130). The flow/utilization may be a count of the service provider 130 as opposed to a percentage of the service provider utilized. For example, the capacity of the service provider 130 and the flow of the service provider 130 may be acquired in at least two ways and dependent upon whether the service provider 130 is multi-threaded or not. In this regard, step 210 of status acquiring protocol 200 is directed to determining whether each service provider 130 of the service provider set 135 is a multi-threaded service provider.

If the service provider 130 is not a multi-threaded service provider, the status acquiring protocol 200 may proceed to step 225. Step 225 of the status acquiring protocol 200 is directed to, for a given service provider 130 of the service provider set 135, acquiring the maximum number of concurrent connections to that service provider 130. In other words, in this example, the capacity of the service provider 130 may be acquired based on the maximum number of concurrent connections that the service provider 130 can support. The number of concurrent connections may be the total number of connections that can simultaneously be processed by the service provider 130 without queuing. After the capacity of the service provider 130 is acquired for that service provider 130, the status acquiring protocol 200 may proceed to step 230. Step 230 is directed to acquiring the current number of active concurrent connections to that same given service provider 130. In other words, the flow of the service provider 130 may be acquired based on the current measure of the utilization of that service provider 130 defined in the measure of the service provider 130.

If it is determined in step 210 that the service provider 130 is a multi-threaded service provider 130, the status acquiring protocol 200 may proceed from step 210 to step 215. Step 215 of the status acquiring protocol 200 is directed to, for a given service provider 130, acquiring the number of active threads and a portion of threads that may be activated as needed. For example, the capacity of the service provider 130 may be acquired based on not only the total number of active threads, but also those threads that may be run but have not yet been created (e.g., the capacity may be based on the maximum number of threads that may be activated). After the capacity of the status provider 130 is acquired for that service provider 130, the status acquiring protocol 200 may proceed to step 220. Step 220 is directed to acquiring the number of current busy threads for that same given service provider 130. In other words, the flow of the service provider 130 may be acquired based on the count of the number of busy threads on that service provider 130.

The acquiring step for each of steps 215, 220, 225, and 230 of the status acquiring protocol 200 (FIG. 3) may include sending a request for status information over the network 50 to a given service provider 130 within its corresponding service provider set 135 and receiving a corresponding response over the network 50. For example and with regard to step 225, the maximum number of concurrent connections to a given service provider 130 may be acquired by sending a request for the maximum number of concurrent connections to that given service provider 130 and receiving a response to the request from that given service provider 130 having the maximum number of concurrent connections. If a response to the request is not received from that given service provider 130 within a predetermined amount of time, the broker 110 may set a default status for that given service provider 130. The default status may include setting the capacity of that given service provider 130 to the last acquired capacity value of that given service provider 130 and assuming that the flow of that given service provider 130 is maxed out (e.g., the current utilization of that given service provider 130 is at 100%). In this regard, when a response to the request is not received from a given service provider 130 within the predetermined amount of time, the calculated price of that given service provider 130 may be raised, which will be discussed in detail below. In one example, the predetermined amount of time is 15 seconds. The predetermined amount of time may be configurable and may be more than or less than 15 seconds.

In either case of a multi-threaded service provider 130 or a single threaded service provider 130, after the capacity of the service provider 130 and the flow of the service provider 130 has been acquired by a broker 110, the status acquiring protocol 200 proceeds to step 235. For purposes of step 235, status information (e.g., capacity and flow of the service provider 130) may be considered to be acquired by either receiving a response to a request for status information or setting the default status of the service provider 130. Step 235 is directed to determining whether status information has been acquired from each service provider 130 of the service provider set 135. If status information has not been acquired from each service provider 130 of the service provider set 135, status acquiring protocol 200 proceeds to and repeats steps 210, 225, 230 (e.g., for a single threaded service provider), 215, 220 (e.g., for a multi-threaded service provider) for each service provider 130 of the service provider set 135. In other words, broker 110 acquires status information from each service provider 130 of the service provider set 135. If status information has been acquired from each service provider 130 of the service provider set 135, status acquiring protocol 200 proceeds to step 240. Step 240 is directed to formulating a non-linear programming problem (e.g., the local optimization problem that each broker 110 may solve in a reasonable time to enable the collection/set of brokers 100 to produce a solution that tracks a globally optimal solution). In other words, the non-linear programming problem is expressed as a non-linear equation/function and optimized weights are chosen (e.g., using at least one processor) for each service provider 130 so that the non-linear equation/function is optimized, which will be discussed in detail below.

FIG. 4 presents an embodiment of a protocol 250 for acquiring status information that may be characterized as an alternative to the status acquiring protocol 200 of FIG. 3. In any case, the status acquiring protocol 250 may be utilized by each broker 110 to acquire and/or request service provider status from each broker 110 within the broker set 100. As discussed above, a broker 110 may acquire status information on each service provider 130 within its corresponding service provider set 135 by polling other brokers 110 within the broker set 100 to allow the requesting broker 110 to estimate/calculate the status information for each service provider 130 within its corresponding service provider set 135. Status acquiring protocol 250 is generally directed towards acquiring status information on each service provider 130 within its corresponding service provider set 135 by requesting the status information over the network 50 from other brokers 110 within the broker set 100 (instead of acquiring such status information directly from a given service provider 130). In this regard, step 255 of status acquiring protocol 250 is directed to sending a request to each broker 110 in the broker set 100 for the number of active connections to a given service provider 130 of its corresponding service provider set 135.

After a request for the number of active connections to a given service provider 130 of its corresponding service provider set 135 has been sent over the network 50 to each broker 110 of the broker set 100, the status acquiring protocol 250 may proceed to step 260. Step 260 of the status acquiring protocol 250 is directed to the requesting broker 110 summing the count of the number of active connections obtained from each broker 110 in the broker set 100. By summing the count of the number of active connections obtained from each broker 110 in the broker set 100, the requesting broker 110 can estimate/calculate (e.g., using at least one processor) the number of concurrent connections open to that given service provider 130. As such, the requesting broker 110 can acquire the total current number of concurrent open connections to that service provider 130. After the requesting broker 110 has acquired the number of active connections to a given service provider 130 from each broker 110 in the broker set 100, the status acquiring protocol 250 may proceed to step 265. Step 265 is directed to determining whether the number of active connections for each service provider 130 of its corresponding service provider set 135 has been obtained. In other words, the requesting broker 110 requests status information from each broker 110 of the broker set 100 for each service provider 130 of its corresponding service provider set 135. In this regard, if the number of active connections for each service provider 130 in its corresponding service provider set 135 has not been obtained by the requesting broker 110, steps 255, 260, and 265 are repeated until the requesting broker 110 requests status information from each broker 110 of the broker set 100 for each service provider 130 of its corresponding service provider set 135. If the number of active connections for each service provider 130 in its corresponding service provider set 135 has been obtained by the requesting broker 110, status acquiring protocol 250 proceeds to step 270. Step 270 is directed to formulating a non-linear programming problem (e.g., the local optimization problem that each broker 110 may solve in a reasonable time to enable the collection/set of brokers 100 to produce a solution that tracks a globally optimal solution). In other words, the non-linear programming problem is expressed as a non-linear equation/function and optimized weights are chosen (e.g., using at least one processor) for each service provider 130 so that the non-linear equation/function is optimized, which will be discussed in detail below.

As described above in relation to the service request distribution/allocation protocol 150 of FIG. 2, each broker 110 will calculate (e.g., using at least one processor) a price for each service provider 130 within its service provider weight set 135 (step 162 of protocol 150) using the status information acquired pursuant to step 160 of protocol 150, and/or status acquiring protocols 200/250. The calculated price assigned to each service provider 130 is updated such that the price reflects expected near-term future demand for the shared service provider 130. The price of each shared service provider 130 reflects the amount of excess capacity that the service provider 130 has for processing service requests. For example, if the demand for a shared service provider 130 is greater than the supply, then the price of the service provider 130 should increase. Conversely, if the demand for a shared service provider 130 is less than the supply, then the price should decrease. The price of each shared service provider 130 is updated according to the difference between the advertised capacity (e.g., service provider 130 capacity as discussed above) of the shared service provider 130 and current demand (e.g., service provider 130 flow as discussed above) for the service provider 130 scaled by a constant factor. In this formulation, the price is bounded below by 0.

A constant step-size parameter is applied to each price update, denoted H, whose value must be greater than or equal to 0. The current price, denoted Hₚ, for each service provider 130 is updated (e.g., using at least one processor) using the following update procedure, where [x]₊=max{x,0}. Let Hₚ^{prior} denote the previous price for service provider 130, fₚ denote the current capacity being consumed when the price is updated (e.g., service provider 130 flow as discussed above), and Cₚ denote the service provider 130 capacity to process requests. As such, the price update equation is given as Hₚ=[Hₚ^{prior}−H (Cₚ−fₚ)]₊. The step-size H determines the magnitude of price updates. That is, if H is too small, then the prices will be slow to react to changes in demand. For example, if price updates are too small and the demand for a service provider 130 is much greater than its capacity, then the price for the service provider 130 may not increase enough to cause a broker 110 to discontinue sending service requests to the highly demanded service provider 130. Alternatively, the step-size H should be large enough to enable the system/network 50 to react to substantial changes in demand (e.g., step-size H must be large enough to cause a sufficient increase in price that will deter recurrent excessive demand for that service provider 130).

As discussed above in relation to service request distribution/allocation protocol 150 of FIG. 2, optimized weights for each service provider 130 (one weight per service provider 130) are derived by each broker 110 (step 164 of protocol 150) using the price data acquired pursuant to step 162 of protocol 150. Deriving optimized weights for each service provider 130 may depend on the price calculated for each service provider 130 (as discussed above) and a preference for each service provider 130 from each broker 110. For example, optimized weights for each service provider 130 of the service provider set 135 may be derived by maximizing the following non-linear equation (e.g., using at least one processor):

Σ[ln(T_{bp}e_{bp})−Hₚe_{bp}],subject to Σₚe_{bp}=1 and ∀p, e_{bp}≧0, where:

Σₚ=a summation of all service providers 130 within service provider set 135;

ln=logarithmic function;

e_{bp}=optimized weight of each service provider 130;

T_{bp}=a preference for each service provider 130 from a broker 110;

Hₚ=a price of each service provider 130;

b=a broker 110; and

p=a service provider 130.

The preference for each service provider 130 may be based on current network latencies from each broker 110 to each service provider 130. Each broker 110 may periodically measure the network latency from the broker 110 to each service provider 130. The preference for each service provider 130 may be inversely proportional to the measured latency from the broker 110 to the service provider 130. In this regard, each broker 110 may set preferences such that the preferred service provider 130 is the network closest service provider 130 that offers the smallest network latency. For example, a higher preference may be assigned to a service provider 130 that is deployed to the same cloud provider as the broker 110 setting the preference and that has the smallest measured network latency from the broker 110 to the service provider 130. As illustrated above in the non-linear equation, the preference will influence the derivation of optimized weights, but the actual distribution of service requests to service providers 130 may be determined by optimizing the non-linear equation given above (e.g., deriving and assigning the derived optimized weights to each service provider 130 of the service provider set 135).

As can be seen from the above non-linear equation, optimizing the distribution of service requests (e.g., maximizing the non-linear equation) is dependent on the prices obtained from each service provider 130 and information that is locally available to each broker 110 (e.g., setting a preference). As such, deriving optimized weights for each broker 110 does not require detailed knowledge of the optimized weights for the other brokers 110 within the broker set 100. Detailed knowledge of the optimized weights for the other brokers 110 within the broker set 100 is instead replaced by a collection of prices for the service provider 130 in the service provider set 135, where each price reflects the current demand for the capacity of each service provider 130 in the service provider set 135.

As discussed above in relation to the service request distribution/allocation protocol 150 of FIG. 2, with the service provider weight set being current (step 166 of protocol 150), it is determined if a given broker 110 has received a request for service from one or more service requesters 120 (step 154 of protocol 150). If a request for service has been received by a broker 110, the broker 110 may convert the derived optimized weights (step 164 of protocol 150) into a cumulative probability mass function (CMF) (step 156 of protocol 150) (e.g., using at least one processor). The CMF is used to select a service provider 130 for each received service request.

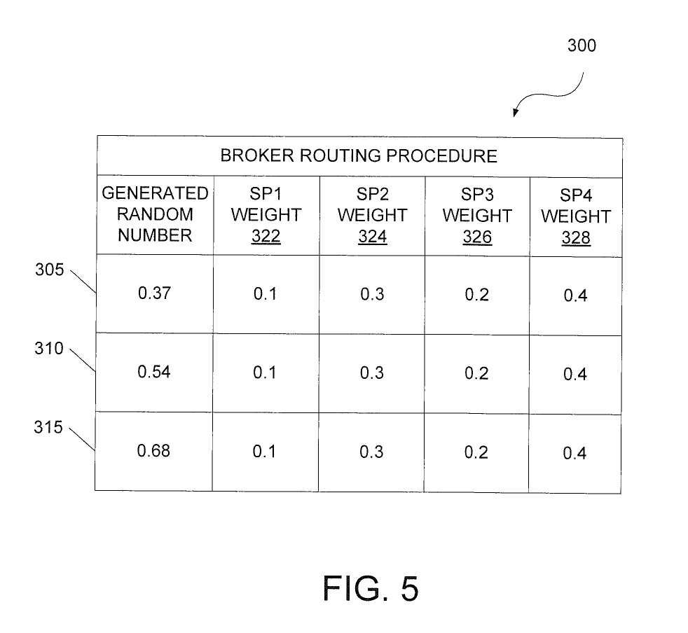

FIG. 5 presents one embodiment of a broker routing procedure 300 based on the CMF which may be utilized by each broker 110 to select and transmit service requests to each service provider 130 within its corresponding service provider set 135. FIG. 5 represents a service provider set 135 including four service providers 130 (designated as SP1, SP2, SP3, and SP4 in FIG. 5). However, any number of service providers 130 may be utilized for distributing service requests via the network 50. As described above in relation to the service request distribution/allocation protocol 150 of FIG. 2, after a current weight is assigned to each service provider 130 of the service provider set 135, the weights of the service providers 130 may be converted into the CMF. In this example, the first service provider SP1 is assigned a weight 322 of 0.1, the second service provider SP2 is assigned a weight 324 of 0.3, the third service provider SP3 is assigned a weight 326 of 0.2, and the fourth service provider SP4 is assigned a weight 328 of 0.4. It can be seen that the sum of the optimized weights for the weighted distribution is equal to 1.

In a first example, when a new service request has been received by a broker 110, a random number 305 may be generated. In this example, the generated random number 305 is 0.37. As such, the broker 110 determines if weight 322 is greater than or equal to random number 305. If weight 322 is greater than or equal to random number 305, SP1 is selected and the service request is transmitted to SP1. If weight 322 is not greater than or equal to random number 305, weight 322 is added with weight 324, and it is determined if the sum of weights 322 and 324 is greater than or equal to random number 305. If the sum of weights 322 and 324 is greater than or equal to random number 305, SP2 is selected and the service request is transmitted to SP2. If the sum of weights 322 and 324 is not greater than or equal to random number 305, weights 322, 324, and 326 are summed together. If the sum of weights 322, 324, and 326 is greater than or equal to random number 305, SP3 is selected and the service request is transmitted to SP3. If the sum of weights 322, 324, and 326 is not greater than or equal to random number 305, SP4 is selected by default and the service request is transmitted to SP4. As such, in this first example, since random number 305 is equal to 0.37, SP2 would be selected for transmitting the received service request (e.g., 0.1+0.3=0.4, which is greater than or equal to 0.37).

When a second new service request is received by broker 110, another random number 310 may be generated. In this example, random number 310 is equal to 0.54. As such, SP3 would be selected to receive this second service request. As such, broker 110 would transmit this second service request to SP3. When a third new service request is received by broker 110, another random number 315 may be generated. In this example, random number 315 is equal to 0.68. As such, SP4 would be selected to receive this third service request. As such, broker 110 would transmit this third service request to SP4. This process may be repeated a plurality of times for each service request received at broker 110. When it is determined that the set of optimized weights associated with a given broker 110 require updating, steps 160, 162, 164, and 166 of the service request distribution/allocation protocol 150 of FIG. 2 may be repeated, as described above.

As discussed above, at each instant in time, each broker 110 in the broker set 100 may have a different representation of each of the capacity and flow, and subsequently the price, values. As such, each broker 110 in the broker set 100 may operate autonomously relative to the other brokers 110 in the broker set 100. In turn, an agent that synchronizes the capacity, flow, and price values across all brokers 110 is not needed on any service provider 130.

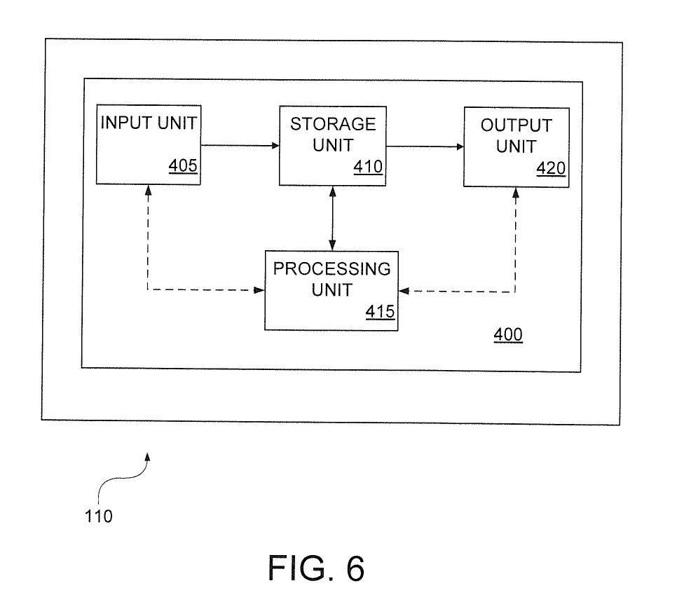

FIG. 6 is a schematic of one embodiment of a data processing system 400 for distributing/allocating service requests. The data processing system 400 may include an input unit 405, a storage unit 410, a processing unit 415, and an output unit 420. In one example, the data processing system 400 is part of a broker 110 of the broker set 100. The input unit 405 may be in communication with the storage unit 410 and/or the processing unit 415 and one or more input ports (not illustrated). For example, the input unit 405 may communicate received data to the storage unit 410 for storing the received data. In another example, the processing unit 415 may communicate an instruction to the input unit 405. The input unit 405 may be part of the processing unit 415. The input unit 405 may include instructions and/or logic for performing input functions. For example, the input unit 405 may receive status information for each service provider 130 of the service provider set 135 and/or may receive service requests from a service requester 120 and/or user, as described above.

The storage unit 410 may be memory of the data processing system 400. For example, the storage unit 410 may store information on a temporary or permanent basis. The storage unit 410 may include read-only memory (ROM) (e.g., PROM, EPROM, EEPROM, EAROM, Flash memory) or read-write memory (e.g., random access memory, hard disk drive, solid state drive), to name a few. The storage unit 410 may be in communication with the input unit 405, the output unit 420, and/or the processing unit 415. For example, the storage unit 410 may receive data/information from the input unit 405 and may send data/information to the output unit 420. The storage unit 410 may send data/information to the processing unit 415 for processing. For example, the storage unit 410 may receive status information from the input unit 405 and may subsequently send the status information to the processing unit 415 for processing. In this regard, the processing unit 415 may include instructions (e.g., computer code) for processing data/information.

In one example, the processing unit 415 is in the form of a central processing unit (CPU) (e.g., one or more processors disposed in any appropriate processing architecture). The processing unit 415 may include instructions of a computer program, for example, for performing arithmetical, logical, and/or input/output operations of the data processing system 400. For example, when the processing unit 415 receives status information on each service provider 130 of the service provider set 135, the processing unit 415 may include instructions for calculating a price for each service provider set (step 162 of protocol 150 of FIG. 2), deriving optimized weights for each service provider 130 of the service provider set 135 (step 164 of protocol 150 of FIG. 2), assigning a current weight to each service provider 130 of the service provider set 135 (step 166 of protocol 150 of FIG. 2), and converting weights of each service provider 130 into a CMF (step 156 of protocol 150 of FIG. 2). In other words, the processing unit 415 of the data processing system 400 (e.g., broker 110) may perform all the processing necessary to distribute/allocate service requests and preferably on a decentralized basis.

The output unit 420 may be in communication with the storage unit 410, the processing unit 415 and/or one or more output ports (not illustrated). For example, the output unit 420 may receive data from the storage unit 410 for transmitting to another device (e.g., service provider 130). In another example, the processing unit 415 may communicate an instruction to the output unit 420. The output unit 420 may be part of the processing unit 415. The output unit 420 may include instructions and/or logic for performing output functions. For example, the output unit 420 may transmit a request for service to a service provider 130, as described above.

The data processing system 400 may include one or more input units 405, storage units 410, processing units 415, and output units 420 and each of the input units 405, storage units 410, processing units 415, and output units 420 may be located at the same location or may be located at different location relative to one another such that service requests are distributed/allocated preferably on a decentralized basis.

The foregoing description of the present invention has been presented for purposes of illustration and description. Furthermore, the description is not intended to limit the invention to the form disclosed herein. Consequently, variations and modifications commensurate with the above teachings, and skill and knowledge of the relevant art, are within the scope of the present invention. The embodiments described hereinabove are further intended to explain best modes known of practicing the invention and to enable others skilled in the art to utilize the invention in such, or other embodiments and with various modifications required by the particular application(s) or use(s) of the present invention. It is intended that the appended claims be construed to include alternative embodiments to the extent permitted by the prior art.

1. A method of routing service requests over a network, comprising the steps of:
deriving, by each broker of a plurality of brokers in a network, an optimized weight for each service provider of a plurality of service providers within a service provider set on said network using a non-linear function, wherein said optimized weight is at least partially based on a current demand for a capacity of said service provider, and wherein said optimized weights for said plurality of service providers collectively define a weighted distribution;
receiving, at each broker of said plurality of brokers, a plurality of service requests over said network for processing at the service provider set; and
routing said plurality of service requests from said plurality of brokers to at least one service provider of said service provider set over said network based on said weighted distribution.

2. The method of claim 1, wherein said non-linear function is subject to Σₚ[ln(T_{bp}e_{bp})−Hₚe_{bp}], subject to Σₚe_{bp}=1 and ∀p, e_{bp}≧0, where:
Σₚ=a summation of all said service providers within said service provider set;
ln=logarithmic function;
e_{bp}=said optimized weight of each service provider;
T_{bp}=a scalar value assigned by each broker of said plurality of brokers to each said service provider within said service provider set based on a unique preference for said service provider;
Hₚ=a price of each said service provider;
b=said broker; and
p=said service provider.

3-4. (canceled)

5. The method of claim 1, wherein each service provider comprises a separate Web server.

6. The method of claim 1, wherein a sum of said optimized weights for said weighted distribution is equal to 1.

7. The method of claim 1, wherein said deriving step comprises:
determining, by each broker of said plurality of brokers, a price for each service provider within said service provider set that reflects the current demand for the capacity of said service provider.

8. The method of claim 7, further comprising:
obtaininq, at each said broker of said plurality of brokers, status information on each service provider within said service provider set, wherein said determining said price for each service provider is based upon said obtained status information received by each broker of said plurality of brokers.

9. The method of claim 8, wherein said status information for each service provider includes a maximum number of connections of said service provider and a number of busy connections of said service provider.

10. The method of claim 8, further comprising:
requesting, by each broker of said plurality of brokers, said status information from each service provider within said service provider set, wherein said obtaining occurs in response to said requesting.

11. The method of claim 8, further comprising:
generating said plurality of brokers, said status information based upon input from at least one other broker within said network, wherein said obtaining occurs in response to said generating.

12. The method of claim 1, wherein said deriving step is repeated a plurality of times.

13. (canceled)

14. The method of claim 1, wherein a first portion of said plurality of service requests are routed during said routing step using a first execution of said deriving step, wherein a second portion of said plurality of service requests are routed during said routing step using a second execution of said deriving step, and wherein said first and second portions are completely independent of one another.

15-16. (canceled)

17. The method of claim 1, further comprising:
converting said plurality of optimized weights into a cumulative probability mass function; and
using said cumulative probability mass function to select said at least one service provider of said plurality of service providers.

18. The method of claim 1, wherein said network is one of a public cloud or a private cloud.

19. (canceled)

20. A method of routing service requests over a network, comprising the steps of:
obtaining, by each broker of a plurality of brokers in a network, status information for each service provider of a plurality of service providers within a service provider set on the network, wherein said status information includes a maximum number of connections of said service provider and a number of busy connections of said service provider;
deriving, by a processor of each broker of said plurality of brokers, optimized weights for each service provider of said plurality of service providers based on the obtained status information, wherein said optimized weights for said plurality of service providers collectively define a weighted distribution;
receiving, at each broker of said plurality of brokers, a plurality of service requests over said network for processing at the service provider set; and
routing each service request of said plurality of service requests from each broker of said plurality of brokers to at least one service provider of said service provider set over said network based on said weighted distribution.

21-38. (canceled)

39. A method of routing service requests over a network, comprising the steps of:
acquiring, by each broker of a plurality of brokers over a network, status information on each service provider within a service provider set that is associated with said broker, wherein each broker of said plurality of brokers acquires the status information in a manner that is temporally independent from other brokers of said plurality of brokers;
deriving, by each broker of said plurality of brokers with said acquired status information, a weighted distribution that comprises an optimized weight for each service provider within said service provider set;
receiving, by each broker of said plurality of brokers, a plurality of service requests over said network; and
routing, by each broker of said plurality of brokers over said network, said received service requests to one or more of said service providers of the service provider set associated with said broker using said derived weighted distribution.

40-60. (canceled)

61. The method of claim 39, wherein said optimized weight for each service provider is at least partially based on a current demand for a capacity of said service provider.

62. The method of claim 39, wherein each broker of said plurality of broker performs said deriving step autonomously from other brokers of said plurality of brokers.

63. The method of claim 1, wherein each of said deriving, receiving and routing steps is autonomously performed by each broker of said plurality of brokers in said network.

64. The method of claim 63, wherein a first broker of said plurality of brokers derives a first optimized weight for a first service provider of said plurality of service providers, wherein a second broker of said plurality of brokers derives a second optimized weight for the first service provider, and wherein the first and second optimized weights are different.

65. The method of claim 1, wherein each optimized weight of said plurality of optimized weights is at least partially based on a preference for each service provider of said plurality of service providers by each broker of said plurality of brokers, and wherein said preference is inversely proportional to a current network latency from each broker of said plurality of brokers to said service provider.
